(19) United States
(12) Patent Application Publication
(10) Pub. No.: US 2017/0213244 A1
(43) Pub. Date: Jul. 27, 2017

(54) METHOD OF ADVERTISING AND PUBLIC SERVICE

(71) Applicant: James H. Johnson, JR., Lexington, KY (US)

(72) Inventor: James H. Johnson, JR., Lexington, KY (US)

(21) Appl. No.: 15/481,544

(22) Filed: Apr. 7, 2017

Related U.S. Application Data
(63) Continuation-in-part of application No. 13/968,989, filed on Aug. 16, 2013.
Application No. 13/968,989 is a continuation-in-part of application No. 12/051,427, filed on Mar. 19, 2008, now abandoned.
Application No. 12/051,427 is a continuation-in-part of application No. 11/996,759, filed on Jan. 25, 2008, now abandoned.
(60) Provisional application No. 60/896,361, filed on Mar. 22, 2007.
(60) Provisional application No. 60/727,136, filed on Oct. 14, 2005.
(60) Provisional application No. 60/702,476, filed on Jul. 26, 2005.

(51) Int. Cl. G06Q 30/02; H04W 4/12; H04L 12/58; H04W 4/22

(52) U.S. Cl. CPC G06Q 30/0252; H04W 4/22; H04W 4/12; H04L 51/32; G06Q 50/01

(57) ABSTRACT

A method of growing an advertising business and promoting public welfare includes steps of: (a) working with a government authority to enhance disaster preparedness in a community, (b) placing a storage structure at a site located in that community, (c) allowing the government authority to use storage space in the storage structure as needed for the welfare of the community and (d) maintaining a right to market advertising on the storage structure.

This application is a continuation-in-part of U.S. patent application Ser. No. 13/968,989, filed on 16 Aug. 2013 which is a continuation-in-part of U.S. patent application Ser. No. 12/051,427 filed 19 Mar. 2008 which claims the benefit of U.S. provisional patent application Ser. No. 60/896,361 filed on 22 Mar. 2007 and is a continuation-in-part of prior U.S. application Ser. No. 11/996,759 filed on 25 Jan. 2008, which is the National Stage of International Application No. PCT/US2006/028760 filed on 25 Jul. 2006 which claims the benefit of U.S. provisional patent application Ser. Nos. 60/727,136 filed on 14 Oct. 2005 and 60/702,476 filed on 26 Jul. 2005.

### TECHNICAL FIELD

The present invention relates to the fields of advertising as well as public service and disaster relief.

### BACKGROUND OF THE INVENTION

The catastrophic destruction in New Orleans by hurricane Katrina has highlighted a need to improve the disaster preparedness of “at risk” population centers. This is true whether those population centers are under threat of a natural disaster such as hurricane, earthquake, tidal wave, wildfire, flood and/or tornado or man-made disaster such as environmental accident and/or terrorist attack. Significantly, roads and bridges may be washed out and destroyed after such a disaster. Those not destroyed are likely to be blocked by high water, downed power lines or other debris.

As a result, ground transportation is greatly limited or effectively prevented. People are only able to reach areas within walking distance. Relief agencies are unable to deliver relief supplies by road until the roads are repaired and/or cleared. In effect, large segments of the population may be isolated. This is particularly true during the first 24 to 48, even 72, hours following a disaster.

In the past, government and private disaster relief efforts have consisted of staging relief supplies at a location outside the “at risk” area but close enough to allow for deployment within a reasonable time frame. In accordance with this approach, many disaster relief supplies following Katrina came from or were routed through Atlanta, Ga. Due to the distance of Atlanta from the population in need of relief supplies and the condition of the road system following the disaster, few supplies reached the people in need during the first, critical 24 to 48 hours. Even when the weather cleared sufficiently and airports were prepared to receive supply planes, the local roads required repair and clearing to allow those supplies to reach the majority of the population in need.

Recognizing the inability of the above approach to provide relief during the early stages following a disaster, it has recently been proposed to load bottled water onto trucks and move those trunks into an at risk area based upon forecasts of a hurricane's path and likely point of landfall. At first, it appears that such an approach might be effective. However, upon further consideration, it is clear that in many cases even this approach will not be an effective solution.

More specifically, the first priority for the government is to evacuate as many people as possible from the path of a hurricane. In many cases, roads are made one-way, leading away from the risk area, so that more people can be evacuated in a shorter period of time. If the water supply trucks are to reach the area in the path of the storm, they must travel against the flow of evacuation traffic. So as not to interfere with evacuation, the water trucks need to be deployed prior to evacuation and days before the hurricane is forecast to make landfall. Hurricanes are often unpredictable and change path, striking land hundreds of miles from predictions that are less than a few days old. Thus, the required early deployment of the water trucks increases the risk that the trucks and supplies are deployed to the wrong area. Further, even if deployed to the proper area, the underside of trucks and trailers are open. Hurricane force winds are capable of getting under and lifting a truck and/or trailer thereby placing the precious drinking water cargo at risk of loss. In addition, it should be appreciated that other disasters such as but not limited to tornadoes, earthquakes, floods, terrorist attacks and industrial environmental accidents cannot be effectively predicted or forecast in any manner. Thus, little or no warning is provided. In these situations, this latest approach is completely ineffective as a disaster preparedness measure.

The present invention relates to a new and effective approach for increasing or enhancing the disaster preparedness of a community in response to any disaster including those that can be forecast and those that cannot be forecast. The present method is the first to insure that disaster relief supplies, including but not limited to staples, such as water, food and medical supplies are available in appropriate quantities for a given population on an as needed basis during the first 24 to 48 hours after a disaster. As a result, the effected population has access to staples during the time that government and private disaster relief agencies are mobilizing to assist and roads and infrastructure are being repaired and cleared to allow remote supplies to be delivered in quantity to people in the disaster area.

### BRIEF DESCRIPTION OF THE DRAWING FIGURES

The accompanying drawings incorporated in and forming a part of this specification, illustrate several aspects of the present invention and together with the description serve to explain certain principles of the invention.

FIG. 1 is a perspective view of the integrated advertising and storage structure of the present invention;

FIG. 2 is a schematical end elevational view of the structure of FIG. 1 through the open end doors;

FIG. 3 is a schematical view showing an electronic display device mounted on a side wall, end wall or doors of an integrated advertising and storage structure;

FIG. 4 is a schematical view showing an electronic display device mounted in a cavity in a side wall, end wall or door of an integrated advertising and building structure;

FIG. 5 is a diagrammatic view in accordance with the present invention of a representative environment for pinpoint broadcasting;

FIG. 6 is a diagrammatic view in accordance with the present invention of a representative computing system environment for structures in which the invention may be practiced;

FIG. 7 is a flow chart in accordance with the present invention for displaying pinpoint broadcasts;

FIGS. 8a and 8b are tables in accordance with the present invention of a representative manner for displaying pinpoint broadcasting; and

FIG. 9 is a schematical block diagram of one possible community disaster safety network.

### DETAILED DESCRIPTION OF THE INVENTION

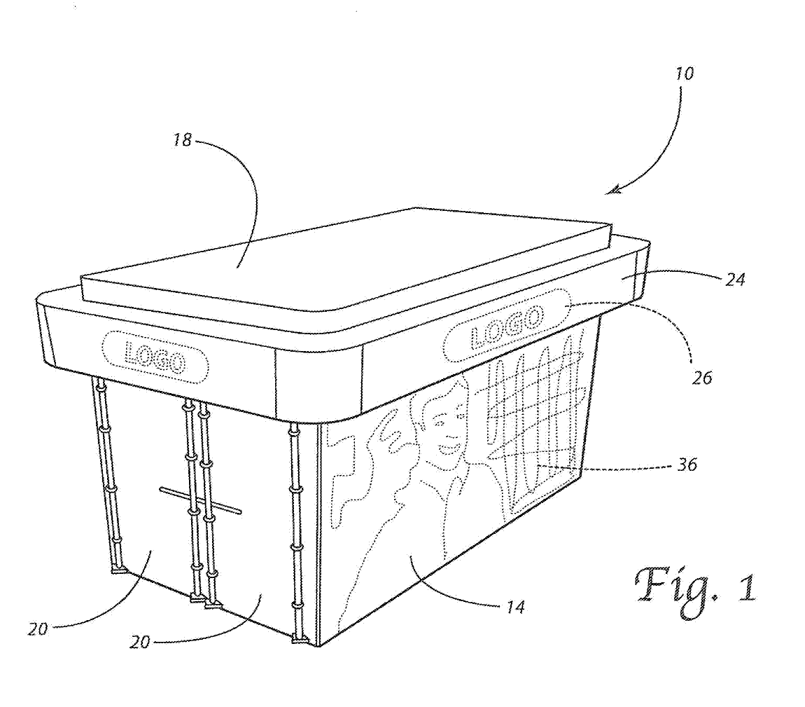

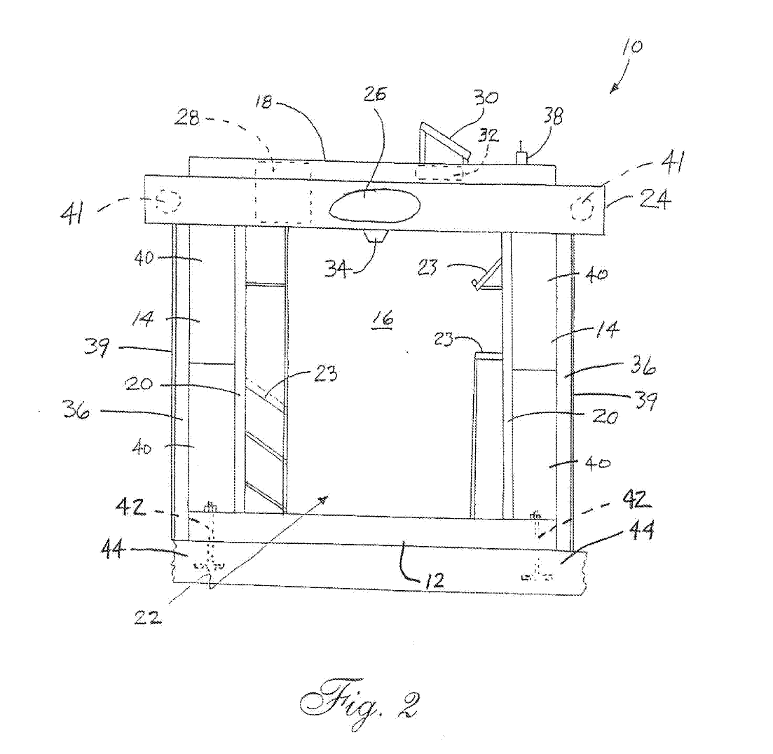

One possible construction of an integrated outbuilding or advertising and storage structure 10 is illustrated in FIGS. 1-2. More specifically, the structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior space 22. That storage space 22 may be customized to meet the needs of the user, including particular rack, shelving and/or partitioning layouts (note shelves 23) as required or desired.

Similarly, the exterior of the structure 10 may be customized to match the trade dress of substantially any desired party and/or architectural features of any building near which the structure 10 may be placed into service. Thus, for example, the structure 10 may include a decorative roof cap 24 sized and shaped to desired specifications. The roof cap 24 may include advertising, trade dress or logo 26 if desired and/or as allowed by local regulations.

The structure 10 may also be equipped with various electrical and/or mechanical systems. For example, air conditioning, refrigeration or other temperature control unit 28 may be provided on the structure 10 in order to provide climate control of a portion or all of the space 22 within the storage structure. Accordingly, staple products such as drinking water and food may be stored at desired temperatures even in hot and humid environments. This increases the shelf life of disaster relief supplies and insures that those supplies may be effectively made available to the community on a permanent basis 24 hours a day, seven days a week, 365 days a year.

In addition, the structure 10 may be equipped with a solar panel 30 and cooperating battery 32 to store energy for powering an internal lighting system 34 for illuminating the space 22. Alternatively, the various electrical and mechanical components of the structure 10 may also derive their power from tapping into the lines of the local electrical utility company and/or from connection with some other form of auxiliary power source such as electric generator or fuel cell powered system. Such an auxiliary power source may provide power to the electrical systems of the structure 10 when electric utility company service is off-line for any reason.

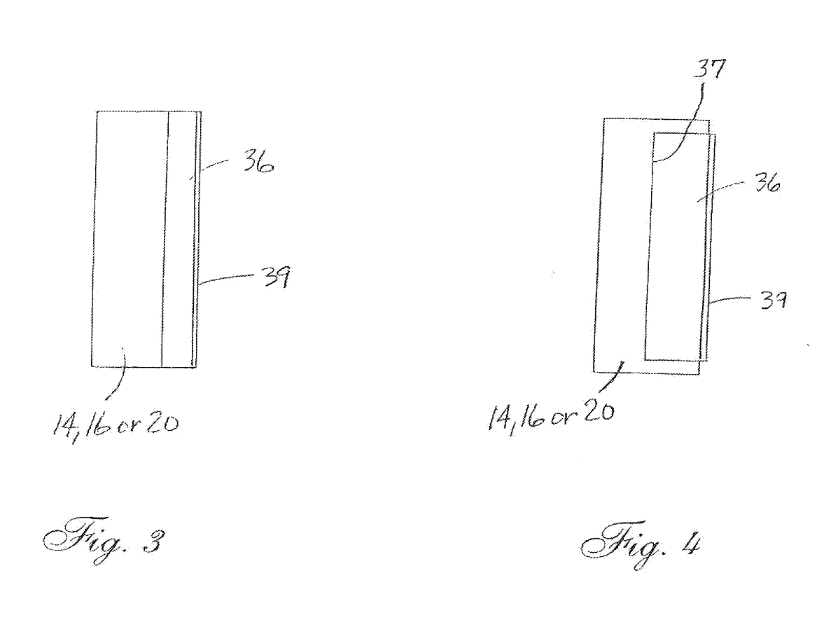

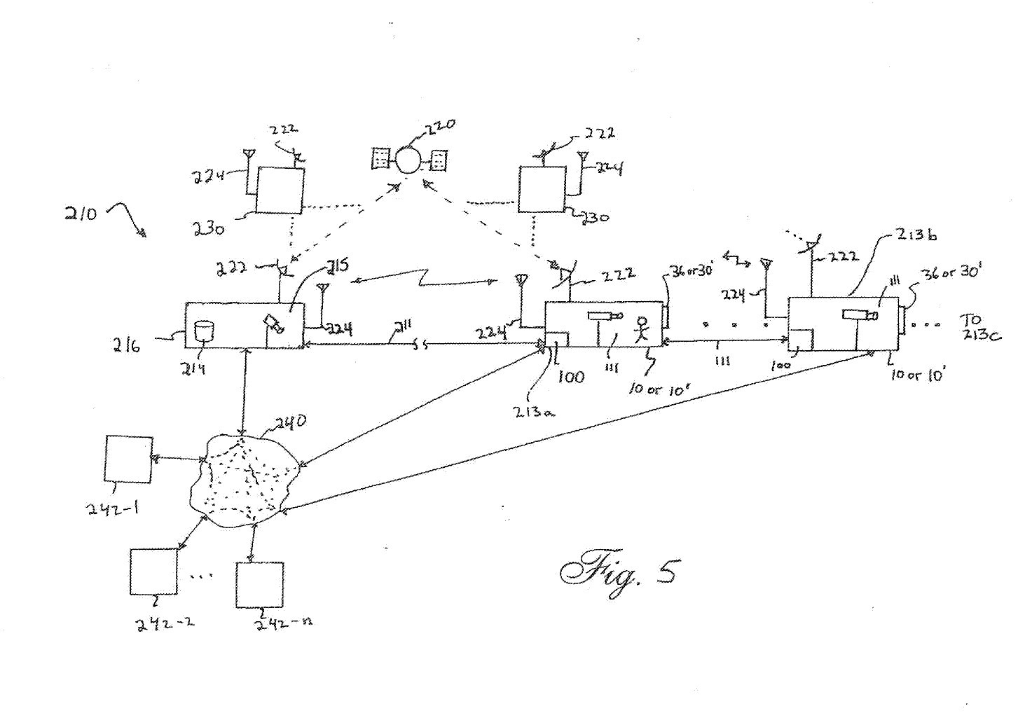

An electronic display device such as a message center or video monitor 36 may be mounted on the surface of the side wall 14, end wall 16 or door 20 as illustrated in FIGS. 2 and 3 or recessed in a cavity 37 in such a wall as illustrated in FIG. 4. A transparent, shatterproof shield 39 may be provided over the device 36 to protect it from vandalism. The monitor 36 may take substantially any appropriate form including but not limited to a liquid crystal display, LED display or a plasma monitor. The device 36 may also include one or more speakers 41 for the presentation of audio. Thus, audio/video advertising is possible. In this way, TV-like advertising is brought out of the home to a potential customer at or near a point of sale where it can be most effective. Still further, the structure 10 may incorporate a radio transmitter 38 for the transmission of audio such as low wattage transmission on 89.1 FM where noise concerns, ordinances or the particular site prevent the presentation of an audio feed through a speaker.

It should also be appreciated that public service messages may be broadcast in real-time over the monitor 36 and speaker 41 systems. Thus, important messages such as Amber Alerts may be broadcast to the community at a moment's notice. Similarly, in the event of a natural or man-made disaster, emergency messages may be broadcast at a moment's notice. These can take any form including, for example, weather warnings, evacuation route directions and directions to emergency shelters or sources of emergency supplies.

The structure 10 may be constructed, for example, from modular building materials such as prefabricated panels 40 of the type shown and described in, for example, U.S. Pat. No. 6,279,287 to Meadows, U.S. Pat. No. 5,373,678 to Hesser and U.S. Pat. No. 6,119,427 to Wyman et al. Such modular panels 40 typically incorporate a core of thermal insulating material sandwiched between metal or plastic sheathing. Such a construction provides both efficient and effective control of the temperature and humidity of the environment in the internal space 22 and excellent inclement weather durability for a long, low-maintenance service life. Structures 10 constructed from such modular building panels 40 are also characterized by high strength and will resist high winds and maintain a weather-tight enclosure to protect products held in the space 22 from inclement weather. In fact, such structures may be easily anchored to the ground such as by means of cooperating nut and bolt anchors 42 where the bolt is received and held in an underlying poured concrete pad 44. Such structures may be specifically designed to withstand winds associated with Category 3, Category 4 and Category 5 hurricanes as desired. Thus, the structures 10 are ideal to store emergency relief supplies or provisions. The modular panels 40 also allow the structure 10 to be quickly and easily erected and subsequently removed in a minimal amount of time while producing a minimum of mess.

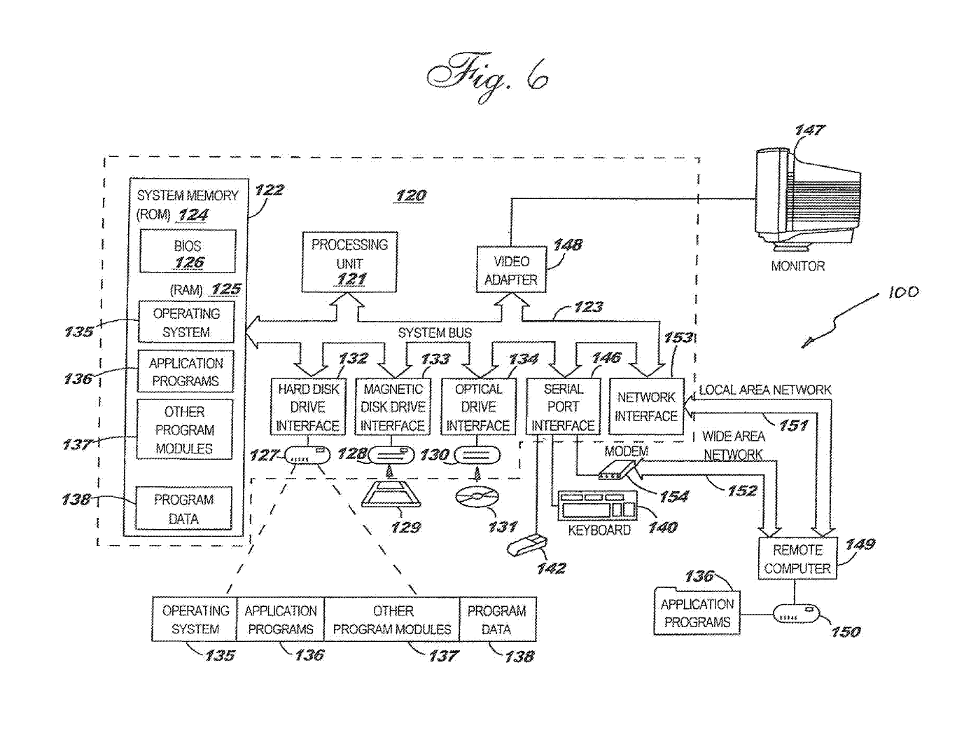

In accordance with the present method, broadcasting includes the feeding of selected static or video images (and/or attendant audio) to the video display devices 36. In this regard, FIG. 5 contemplates a communications environment 210 having utility in the context of the invention. In one aspect, the structure 10 includes a computing system environment 100. The environment 100 may be entirely or partially in the interior space 22 (FIG. 2) of the structure 10. The environment 100 communicates locally or remotely with the to-be-aired advertising or emergency message for display on one or more of devices 36, for example. If local, it may be in the form of advertisements or emergency messages originated and embodied as computer software or stored information of the computing system environment or advertisements or messages originated live at 111 and displayed live or delayed. If remote, it may be in the form of advertisements or messages originated and stored at wired and/or wireless platforms or central facilities 216 having one or more servers, databases, etc. 214 or advertisements or emergency messages originated live at 215. In the wireless aspect, uni- or bi-directional communications occur via a satellite 220 and attendant satellite dishes 222, for example. Alternatively, or in addition, it includes line of sight or other communications between antennas 224. Of course, the communications may include AM, FM, PSK, QAM or other modulation schemes. Appreciating the environment 210 may be geographically large, one or more repeating stations 230 may also be positioned variously in establishing the communication schema. In the wired aspect, the databases 214 connect directly via wire 211 to the structures 10 or 10′ and/or to one or more network connections nebulously given as element 240. Of course, emerging technologies, such as Wi-Fi, have made even this traditionally wired connection completely wireless. In turn, structures 10 are variously connected that engage in the pinpoint dissemination of advertising or public service messaging. Also, other sources of advertising and public service messaging 242 are contemplated. In this regard, the sources include advertising agencies, distributors, media outlets, such as iTunes®, radio and television stations, and the like.

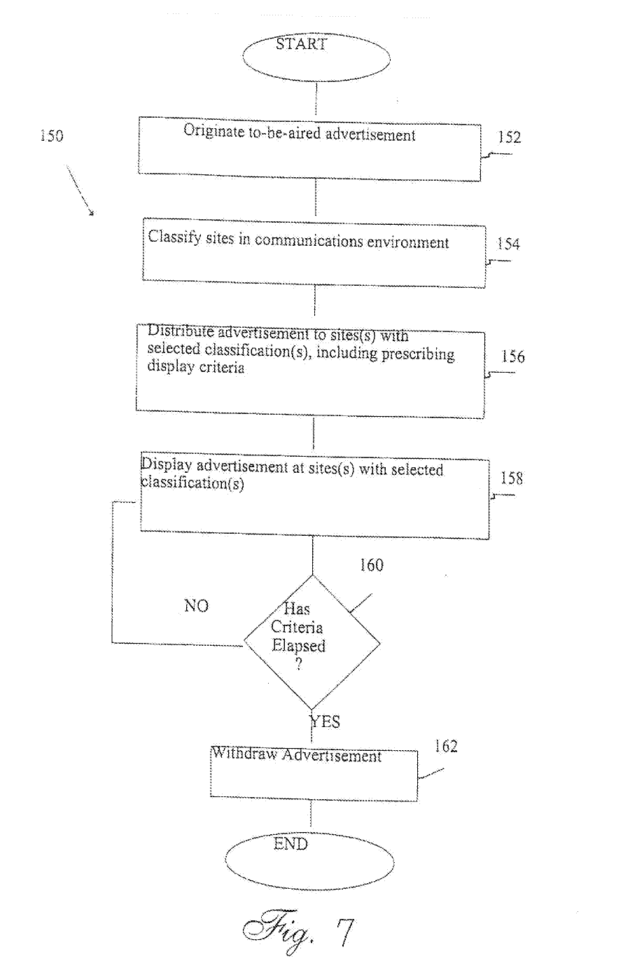

With reference to FIG. 6, a representative computing system environment 100 is given. That is, FIG. 6 provides a brief, general description of a suitable computing environment in which either the structure or processing of embodiments may be implemented. Since the following may be computer implemented, particular embodiments may range from advertisements/messages arranged as computer executable instructions as part of computer readable media or memory (e.g., commonly “software”), to firmware or to hardware used in any or all of the following depicted structures. Implementation may additionally be combinations of the foregoing.

When described in the context of computer readable media or memory having computer executable instructions, it is denoted that the instructions include program modules, routines, programs, objects, components, data structures, etc. that perform particular tasks or implement particular abstract data types upon or within various structures of the computing environment. Executable instructions exemplarily comprise instructions and data which cause a general purpose computer, special purpose computer, or special or general purpose processing device to perform a certain function or group of functions.

The computer readable media, where advertising/messaging or other aspects of the invention may directly reside, can be any available media which can be accessed by a general purpose or special purpose computer or device. By way of example, and not limitation, such computer readable media can comprise RAM, ROM, EEPROM, CD-ROM or other optical disk storage devices, magnetic disk storage devices, combinations thereof or any other medium which can be used to store the desired executable instructions or data fields and which can then be accessed. With reference to FIG. 6, an exemplary system for implementing the invention includes a general purpose computing device in the form of a conventional computer 120. The computer 120 includes a processing unit 121, a system memory 122, and a system bus 123 that couples various system components including the system memory to the processing unit 121. The system bus 123 may be any of the several types of bus structures including a memory bus or memory controller, a peripheral bus, and a local bus using any of a variety of bus architectures. The system memory 122, where advertising/messaging or other aspects of the invention may directly reside, includes read only memory (ROM) 124 and a random access memory (RAM) 125. A basic input/output system (BIOS) 126, containing the basic routines that help to transfer information between elements within the computer 120, such as during start-up, may be stored in ROM 124. The computer 120 may also include a magnetic hard disk drive 127, a magnetic disk drive 128 for reading from and writing to removable magnetic disk 129, and an optical disk drive 130 for reading and writing to an optical disk 131 such as a CD-ROM or other optical media. The hard disk drive 127, magnetic disk drive 128, and optical disk drive 130 are connected to the system bus 123 by a hard disk drive interface 132, a magnetic disk drive interface 133, and an optical drive interface 134, respectively. The drives and their associated computer-readable media provide nonvolatile storage of computer readable instructions, data structures, program modules and other data for the computer 120 or advertising/messaging for the structure 10 or view screen 10′ of the invention.

Although the exemplary environment 100 employs a hard disk, a removable magnetic disk 129 and a removable optical disk 131, it should be appreciated by those skilled in the art that other types of computer readable media exist which can store data and/or advertising/messaging accessible by a computer, including magnetic cassettes, flash memory cards, digital video disks, removable disks, Bernoulli cartridges, random access memories (RAMs), read only memories (ROM), downloads from the Internet and the like. Other storage devices are also contemplated as available to the exemplary computing system. Such storage devices comprise, but are not limited to, any number or type of storage media including, but not limited to, high-end, high-throughput magnetic disks, one or more normal disks, optical disks, jukeboxes of optical disks, tape silos, and/or collections of tapes or other storage devices that are stored off-line. In general, the various storage devices may be partitioned into two basic categories. In the first, local storage is that which contains information that is locally available to the computer system. In the second, remote storage is that which includes any type of storage device that contains information that is not locally available to a computer system. While the line between the two categories of devices may not be well defined, local storage has a relatively quick access time and is often used to store frequently accessed data, while remote storage has a much longer access time and is often used to store data that is accessed less frequently. The capacity of remote storage is also typically an order of magnitude larger than the capacity of local storage. In either instance, the storage needed for the invention may occur remotely or locally. In either storage, one or more application programs 136, other program modules 137, and program data 138 are also stored. Representatively, these include, but are not limited to, word processing programs, drawing programs, games, viewer modules, graphical user interfaces, image processing modules, intelligent systems modules or other known or hereinafter invented items.

To enter commands and information into the computer 120 and to manipulate data, users utilize input devices such as a keyboard 140 and a pointing device 142. Other input devices (not shown) may include a microphone, joy stick, game pad, scanner, camera, personal data assistant, or the like. Regardless, these typically connect to the processing unit 121 through a serial port interface 146 that couples directly to the system bus 123. It may also connect by other interfaces, such as a parallel port, a game port, a firewire or a universal serial bus (USB). It could even occur wirelessly via RF, Bluetooth, WiFi or the like. A monitor 147 in addition to or in lieu of those previously described connects to the system bus 123 via an interface, such as a video adapter 148. In this manner, users can visualize the commands and information of the environment. In addition to the monitor, the computing system environment often also includes other peripheral devices, such as speakers, printers, scanners, video players, etc. (not shown) that often connect via a parallel port interface (not shown), the serial port interface, USB, Ethernet or other ports.

During use, in addition to or in lieu of the communications environment 210 (FIG. 5), the computer 120 often operates in a networked environment using logical connections to one or more other computing configurations, such as a remote computer 149. Despite its name, the remote computer 149 may broadly be a personal computer, a hand-held device, a multi-processor systems, a micro-processor-based or programmable consumer electronic device, a minicomputer, a computer cluster, a main frame, a server, a router, a network PC, a peer device or other common network node directly (e.g., hard wired) or indirectly (e.g., the Internet, intranet, etc.) connect to the computer 120. It also typically includes many or all of the elements described above relative to the computer 120 although only a memory storage device 150 having application programs 136 has been illustrated. Some of the typical logical connections between the computer 120 and the remote computer 149 include a local area network (LAN) 151 and/or a wide area network (WAN) 152 that are presented here by way of example and not limitation. When used in a LAN networking environment, the computer 120 is connected to the local area network 151 through a network interface or adapter 153. When used in a WAN networking environment, the computer 120 typically includes a modem 154, T1 line, satellite or other means for establishing communications over the wide area network 152, such as the Internet. The item 154, which may be internal or external, is connected to the system bus 123 via the serial port interface 146.

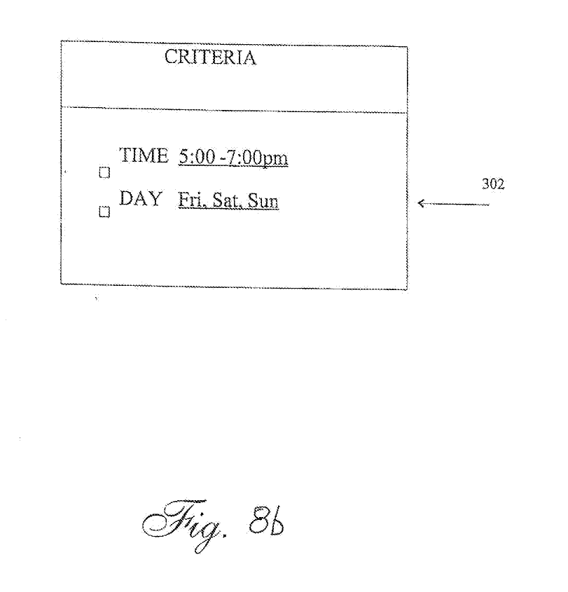

Referring again to FIG. 8, one or more methods of the invention may further include classifying the multiple sites 213a, 213b and broadcasting the advertising/messaging from the central facility 216, for example, only to sites of a selected classification, e.g., 213a or 213b. Such classifications include, for example, locations of the site and/or the type of business located adjacent the site. For example, a beverage manufacturer may desire to run a promotion at convenience stores in Kentucky and Indiana. Utilizing the present method that a beverage manufacturer (e.g., 242-1) may run an audio and video advertisement for their beverage that will be displayed on video display devices 36 only sited at convenience stores in those states, e.g., 213a, selling the particular product. Similarly, the producer of suntan lotion (e.g., 242-2) can pinpoint a target audience at site 213b by utilizing the present method to run an audio/video advertisement for suntan lotion only at sites adjacent beach locations. In the same way, a manufacturer of tires can run an audio/video advertisement on the devices 36 at sites located adjacent tire change centers, auto parts stores, gas stations and the like. Further, a restaurant chain like Kentucky Fried Chicken® could choose to run an audio/video advertisement for one week only at sites it owns or franchises and then choose to run such advertising at highway gas station sites the next. This might be an advisable marketing strategy during, for example, spring break when many families traveling the highways need to make a stop for food.

Further, it is possible to individually identify each site and broadcast the selected static or video images only to selected individually identified or targeted sites as desired. This is a particularly useful tool to relief agencies trying to provide specific disaster messages to the public at specific locations following a disaster. In this regard, signals can be broadcast from one location to another with front end identifiers that only recipients having that identifier can receive or respond to. Toward this end, it should be appreciated that operating systems for the monitor 36 on the structures 10 should be compatible with the Integrated Public Alert and Warning System (IPAWS) and/or the Emergency Alert System (EAS) used by the federal, state and local emergency management agencies. Further, with regard to advertising, the advertising presented at each site may be limited to only certain times such as prime drive time during morning or afternoon rush hour or perhaps in the evenings or only on particular days. In this regard, time stamps are able to be encoded in signals that indicate a time frame in which the advertising may be valid. The advertising on the display devices 36 may be marketed using a cloud-network system if desired.

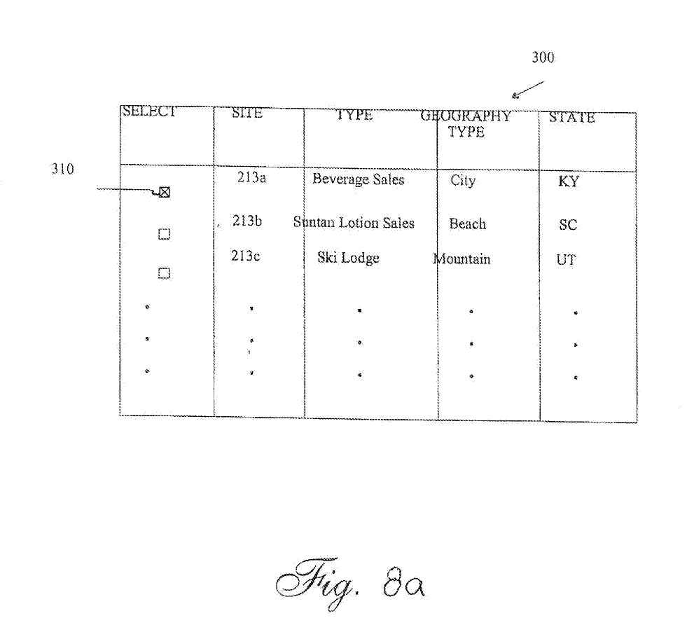

With primary reference to FIG. 7, and corresponding secondary reference to FIGS. 5, 6, 8a and 8b, a flow chart 150 for a method of the invention includes originating to-be-aired advertisements/public service messages 152. In this aspect, it is contemplated that works of authorship will be fixed in a tangible medium of expression, such as by filming, recording, drawing, taping or the like actors, voices, sounds, pictures, figures, scenes, songs, music, etc. that together depict a desired advertisement. In another aspect, this includes performing all or portions of the advertising/messaging at any of the sites 213, the central facility 216, or elsewhere 242.

At step 154, the sites 213 of the communications environment are classified. Representatively, this includes the tables 300 and 302 of FIG. 11. Namely, the tables are preferably screen shots of the computing system environment from monitor 147 that are developed and stored on a media. Also, the tables include a classification scheme whereby the sites 213 of the communications environment are organized according to various notations, such as Type, Location, Geography Type, State, etc. In this regard, a user can classify the sites per a given advertisement by Selecting one or more of the sites at 310, especially via the assistance of a pointing device 142. Naturally, skilled artisans can contemplate additional schemes. Then, at the same time or later, criteria 312 per a given advertisement/message can be made. That is, a specified time or day of display can be set for the classified site to pinpoint the advertisement or public service message.

Upon selection, the sites are classified per the advertisement/message and distributed at step 156, including the prescribed criteria. Distribution includes wireless, wired, hand-to-hand, ground, air, etc. to a classified site 213. The advertisement/message is then installed in the computing system environment 100 for display on the device 36. At step 160, if the criteria has elapsed, the advertising/messaging is withdrawn. If not, it is continued to be displayed at 158 until eventually the criteria elapses and is withdrawn.

In any embodiment, certain advantages of the invention are readily identifiable. Specifically, the present invention allows advertisers to reach the intended audience at the most desirable time and place for the most effective use of the advertising dollar. The present method also allows the advertiser to bring the effectiveness of TV advertising out of the home to the “on the go” populace at or near the point of sale where it can be more effective. Similarly, the system allows pinpoint broadcasting of public service messages including but not limited to Amber Alert messages, weather warnings, information respecting traffic conditions and even available evacuation routes and disaster messages to inform the general public as deemed fit by emergency management agencies, homeland security or the like.

The method of the present invention will now be described in detail. That method relates to the growing of an advertising business while simultaneously promoting public welfare. The method may be broadly defined as comprising the steps of working with a government authority to enhance disaster preparedness in a community, placing a storage structure 10 at a site located in said community, allowing the government authority to use the storage space 22 in the storage structure 10 as needed for the welfare of the community and maintaining the right to market advertising on the storage structure. For purposes of this document, “government authority” means substantially any government agency or official including but not limited to a mayor, an emergency management agency, a homeland security agency and/or a health department. This includes individuals, agencies and departments at the federal, state and local levels.

The method may further include obtaining help from the government authority in finding a site for a storage structure 10 and/or gaining any necessary approval or permitting for presenting advertising on the storage structure. Further, the method may include stocking the storage structure 10 with disaster relief supplies such as staples for survival including drinking water, bottled drinking water, food and medical supplies such as bandages and trauma kits. For purposes of this document, “disaster relief supplies” refers to supplies of water, food, medicine and useful products and equipment purposefully stored and maintained for use in response to a disaster or emergency situation. Thus, the disaster relief supplies are only distributed to the public or members of the community in the event of a disaster. Since the marketing or selling of advertising on the storage structure generates the revenue to pay for the construction, deployment and stocking of the storage structure 10, the government has an incentive to find high traffic sites for the structures 10 and approve the advertising. In this manner, the present method advantageously provides the community with a stock of emergency relief supplies that are permanently located in the community and available for distribution by the government authority 24 hours a day, seven days a week, 365 days a year as needed. Since the supplies are in place prior to and in anticipation of a possible disaster, the present method insures that the community will have access to drinking water, food and medical supplies during the critical first 24 to 48 hours after the disaster while remote relief efforts are being mobilized and roads are being repaired and cleared.

Stated another way, the method may include the steps of (a) stocking the plurality of storage structures with disaster relief supplies, (b) dedicating those disaster relief supplies exclusively to disaster relief, (c) exclusively maintaining those disaster relief supplies in the plurality of storage structures for distribution in response to a disaster event and (d) distributing those disaster relief supplies to members of the community following the disaster event. The method may also include the step of restricting distribution of the disaster relief supplies to members of the public following a disaster event. As such, the proposed disaster safety network and method are the antithesis of any device or method known in the art and used to store goods owned by a specific entity or to commercially transfer goods between two entities.

The method further includes the step of obtaining help from the government authority to acquire a right to place a storage structure 10 on government property. That property includes but is not limited to roadway medians and right-of-ways, parks, post offices, space adjacent emergency shelters and schools. Typically, school gymnasiums function as emergency shelters and locating drinking water and other relief supplies nearby is particularly beneficial to the population of the community. Parking lots or green space near a gymnasium make fine sites for a storage structure 10.

The method further includes using the goodwill generated by enhancing the disaster preparedness of the community to help obtain a site for the storage structure 10 from a property right holder. For purposes of this document a “property right holder” includes any party holding a real property right including but not necessarily limited to a lease holder and an owner. The method also includes using the goodwill to help obtain an advertiser for the storage structure 10, thereby insuring a good revenue stream for restocking existing structures as necessary and constructing and stocking additional structures to benefit the community.

The method also includes placing or deploying storage structures 10 at locations such as hospitals, shopping malls, retail stores clinics, alcohol beverage control stores and retirement homes. The storage structure 10 may be located in a parking lot adjacent a building ingress and egress point or a parking lot ingress and egress point for high visibility. Those structures 10 located at hospitals and clinics may be equipped to function as emergency triage units or overflow emergency rooms if desired. The method also includes working with a retail chain to obtain the right to place storage structures 10 at multiple sites controlled by the retail chain. Similarly, the method includes the step of working with any property owner to obtain the right to place storage structures 10 at multiple sites owned by the property owner. Such a property owner includes but is not limited to a shopping mall developer, owner and/or operator.

Similarly, the structures 10 may be deployed at fire stations in and around the community. Such fire stations are often used as rally points for emergency management first responders. Thus, it is convenient to locate emergency relief supplies at the fire stations. Further, the satellite uplink on the structure 10 may function as a back-up communication hub for the fire station if needed due to the loss of normal communication channels as a result of some calamity.

The structures may also be positioned in medians of major high-traffic road arteries so that the emergency messaging may reach a maximum number of people and the supplies may be conveniently loaded onto trucks and delivered where needed. In many cases, traffic barriers may be conveniently maintained in such structures. Such barriers are typically needed in great number when controlling traffic along evacuation routes or closing roads due to high flood waters, downed power lines, washed-out bridges or other reasons. Further, the displays 36 on such a structure 10 are particularly suited for delivering traffic and road construction updates to travelers.

In accordance with yet another aspect of the present invention, the method includes the step of promoting enhanced disaster preparedness by Internet web site. Such a web site may be directed to a group of entities including government authorities, property right holders, advertisers and combinations thereof. In this way it is possible to bring together (a) officials, organizations and agencies responsible for disaster preparedness, (b) potential storage structure 10 site owners and (c) potential advertisers from which revenue is generated to make the program possible.

The method further includes the steps of collecting information from property right holders, government authorities and advertisers connected to the web site. More specifically, information collected includes but is not limited to government authorities requesting inclusion into the disaster preparedness program, property right holders offering potential storage structure sites and advertisers seeking to become part of this important public service initiative by seeking advertising on the storage structures 10. The method further includes advising any government authority how to obtain a storage structure 10 for their community on the Internet web site. Similar advice is provided to any party or entity including hospitals and clinics seeking storage structures 10.

The method includes providing the Internet web site with the ability to accept a request from a government authority for a storage structure 10 for a particular community. Priority will be given to government authorities that provide preapproval of or permitting for the presentation of advertising on the storage structure at the site it is to be located. The method also includes providing the Internet web site with the ability to accept a request from a government authority or a property right holder to provide a site for a storage structure 10. Still further, the method also includes the step of matching a government request for a storage structure 10 in a community with a property right holder willing to provide a site placement right for a storage structure in that community.

In order to aid in acquiring sites for the storage structures 10, the method includes generating revenue from the marketing of advertising on the storage structures 10 and sharing that revenue with the property right holders supplying a site placement right for a storage structure. Still further, revenue may also be shared with the government entity having jurisdiction or control of the site where a structure 10 is deployed.

As noted above, the method also includes the step of displaying public service messages on the storage structures 10. This can include any type of public service message. Examples include but are not limited to health messages, quarantine information, Amber Alert messages, severe weather warnings, traffic alerts, evacuation route information and any other emergency directions and information of any kind.

The method may further include renewing the disaster relief supplies stored in the storage structures 10 as necessary. As part of that effort, bottled drinking water, food and medical supplies being rotated out of the structures may be donated to be used by charitable organizations before the supplies reach their expiration date. Further, the method may include obtaining sponsorship from a charitable organization. That charitable organization may then be promoted by displaying its name and/or logo on the storage structures 10. The method includes the step of targeting growth of the advertising business in hurricane, earthquake, flood, wildfire, tornado, industrial accident and terrorist attack risk areas.

The present invention may be alternatively described as a method of enhancing disaster preparedness in an at risk community. The method includes placing a storage structure 10 holding disaster relief supplies selected from a group including drinking water, bottled drinking water, food, medical supplies and combinations thereof at a site in the community prior to and in anticipation of an actual disaster so that the supplies are permanently available to the community on a 24 hour a day, seven day a week basis.

In this regard, it should be appreciated that the disaster relief supplies are maintained in the structure 10 so as to be available in response to a disaster or emergency event. In other words, they are not used for any other purpose. Toward this end, the doors 20 of the structure 10 are secured by means of a cypher lock 21. The only ones with restricted access to the interior space of the structures are those individuals who stock and maintain the relief supplies and government authority personal who use the supplies in the event of disaster.

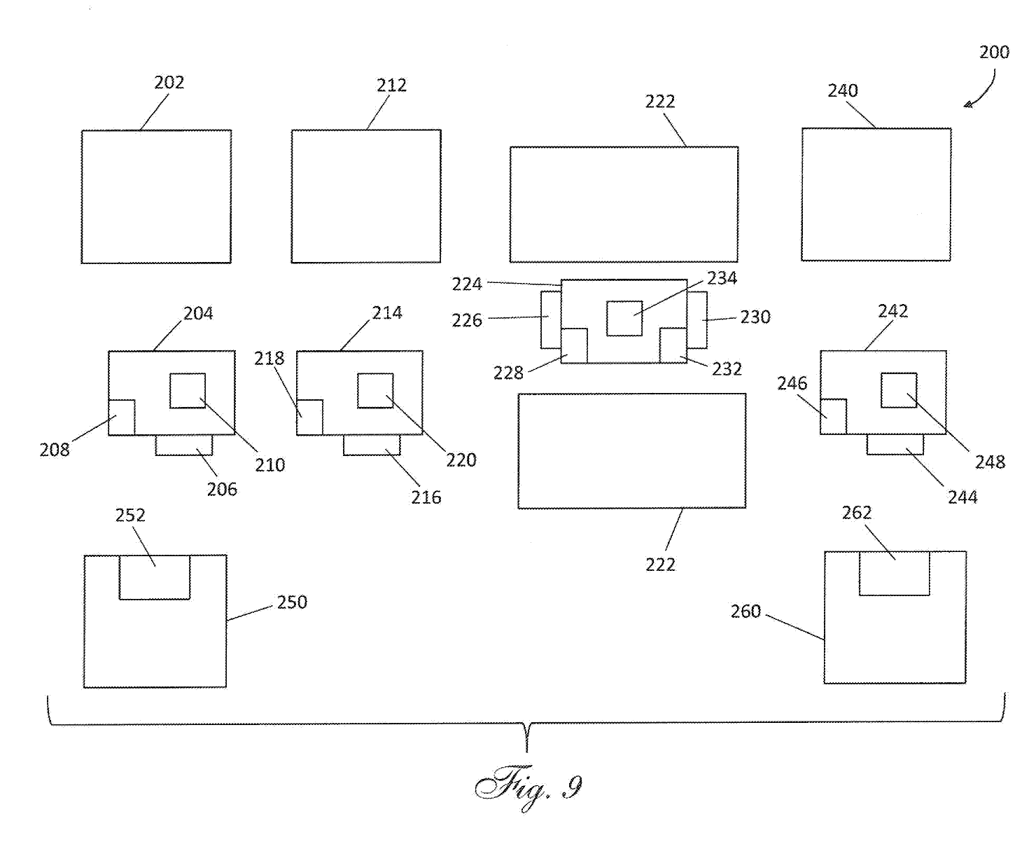

Reference is now made to FIG. 9 illustrating one possible community disaster safety network 200. The network 200 includes a first government building, such as a high school gymnasium 202, which is used to shelter civilians in the event of a disaster. As illustrated, a first storage structure 204 is deployed adjacent the building 202. The storage structure 204 includes a first electronic display device 206, controlled by a first computing device 208, and a first group of disaster relief supplies 210. Supplies 210 for a shelter might typically include drinking water, food, cots and blankets.

The network 200 also includes a second government building, such as a fire station 212, which is used as a rally point for first responders in the event of a disaster. A second storage structure 214 is deployed adjacent the building 212. The structure 214 includes a second electronic display device 216, a second computing device 218 for controlling the second electronic display device, and a second group of disaster relief supplies 220. For first responders, such supplies 220 might include drinking water, flash lights, batteries, communications equipment, chain saws, trauma kits or whatever else may be desired.

Still further, the network 200 includes a third storage structure 224 in the median of a roadway 222. The third storage structure 224 is equipped with two electronic display devices 226, 230, controlled respectively by the computing devices 228, 232. A third group of disaster relief supplies 234 is held in the third storage structure 224. Since these supplies 234 are positioned on a major road artery they may be quickly and easily distributed throughout the community to the extend roads are open. In one possible embodiment, the third group of supplies is traffic barriers which may be used to control traffic along evacuation routes or to close roads in the event of flood waters, downed power lines or bridge washouts.

As further illustrated, the network 200 may also include a fourth storage structure 242 located adjacent a hospital 240. The fourth storage structure 242 includes an electronic display device 244, controlled by a computing device 246, and another group of supplies 248. In one possible embodiment the structure 242 functions as a triage unit to reduce or prevent the overloading of the hospital emergency room in the event of a disaster. In such a situation, the supplies 248 are medical supplies for emergency triage.

The network 200 further includes a computing device 252 at a first remote location 250. In the illustrated embodiment the remote location 250 is an outdoor advertising company and the computing device 252 is used to communicate targeted advertising to one or more of the computing devices 208, 218, 228, 232 and 246 to display that advertising on one or more of the associated electronic display devices 206, 216, 226, 230, 244. As previously indicated, the sale and display of this advertising at high traffic locations pays for the building and operation of the network 200 at no cost to the government or taxpayer. As a result of this approach the community receives the benefit of an enhanced warning and disaster relief supply system which the community might not otherwise be able to afford in these difficult economic times.

The network 200 also includes a computing device 262 at a second remote location 260. In the illustrated embodiment, the remote location 260 is a government agency, such as a state emergency management agency, and the computing device 262 is used to (a) communicate targeted emergency messaging to one or more of the computing devices 208, 218, 228, 232, 246, (b) interrupt advertising and (c) display that emergency messaging on one or more of the electronic display devices 206, 216, 226, 230, 244.

The method further includes providing the storage structure 10 in the community free to the taxpayers. Further, the method may include providing disaster relief supplies in the storage structures 10 free to the taxpayers. Still further, the method may include providing a network of storage structures 10 holding disaster relief supplies at various locations actually in an at risk area. More specifically, the storage structures 10 may be provided adjacent different neighborhoods in the community so as to serve each neighborhood in the event of a disaster.

From the above description, it should be apparent that the disaster safety network 200 has a communications environment 210 configured to allow broadcasting of a specific message from a computing device 252 or 262 at a remote location 250 or 260 to a specific, targeted computing device 208, 218, 228, 232, 246 and a specific targeted location. Toward this end the computing devices 208, 218, 228, 232, 246 at the storage structures are all configured to include a unique identifier to allow targeted messaging as well as allow prioritizing of an emergency message over advertising.

In accordance with an additional aspect, the communications environment 210 may also be configured to allow for the targeted display of messages from social networking platforms such as “tweets” from the Twitter online news and social networking service. The Twitter message or Tweet may have up to 140 characters. The message or Tweet may be displayed on any one or more of the electronic display devices 206, 216, 226, 230, 244 across the entire display device or in a “band” on the display device. So a band may include a rolling character band.

Alternatively, the message or Tweet could be displayed on a separate, dedicated display device (not shown) carried on the storage structures 204, 214, 224, 242.

More specifically, a Twitter message or Tweet may, for example, be broadcast from the computing device 252 at the remote location 250 to one or more specific, targeted locations such as the computing devices 232 and 246 at the third storage structure 224 and the fourth storage structure 242. The Twitter message or Tweet may then be displayed by the computing device 232 on the display device 230 in the median of the roadway 222 and by the computing device 246 on the display device 244 adjacent the hospital.

In the event of a public service emergency or disaster event, an emergency message may be broadcast from the computing device 262 at the remote location 260 to any one or more of the specified, targeted computing devices 208, 218, 228, 232, 246 at the specified, targeted locations. Upon receipt of the emergency message, the targeted computing devices 208, 218, 228, 232, 246 interrupt the display of advertising and/or Twitter messages on the associated electronic display devices 206, 216, 226, 230, 244 and display the emergency message instead.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, combinations of the foregoing are possible, such as the video display devices of the invention being positioned for outdoor viewing, indoor viewing or both. Further, a storage structure may be modified to serve as a field station for use by relief workers. Such a field station might include electric generation equipment, communications equipment, such as a satellite uplink or satellite phone service, and/or bathroom facilities. The electric generation equipment may comprise an electric generator connected to a buried propane tank or natural gas utility lines. Significantly, the satellite communications system will allow for internet service as necessary for the government to properly create, issue and inventory any government subsidy debit cards or other monetary assistance.

Similarly, it should be appreciated that each structure 10 may function as a base unit or support for other equipment desired at a particular location. Such equipment includes but is not limited to civil defense sirens to fill any holes in a siren warning system, traffic cameras to monitor traffic and gas sensors to monitor industrial plant discharges. The embodiments were chosen and described to provide the best illustrations of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A method of enhancing disaster preparedness in an at risk community, comprising;
establishing a disaster safety network for said community by (a) deploying a plurality of storage structures at various locations around said community and (b) providing said disaster safety network with a communications environment configured to allow broadcasting of a specific message to a specific, targeted location;
providing each of said plurality of storage structures with a first computing device configured to include a unique identifier for targeted messaging and to prioritize an emergency message over advertising, and an electronic display device controlled by said first computing device;
communicating said advertising to a targeted first computing device from a second computing device at a first remote location;
displaying said advertising on said electronic display device controlled by said selected first computing device at a targeted location in said community;
communicating said emergency message to said targeted first computing device from a third computing device at a second remote location;
interrupting the displaying of said advertising on said electronic display device controlled by said targeted first computing device;
displaying said emergency message on said electronic display device controlled by said targeted first computing device in response to said communicating of said emergency message;
stocking said plurality of storage structures with disaster relief supplies;
dedicating said disaster relief supplies to disaster relief;
maintaining said disaster relief supplies in said plurality of storage structures for distribution in response to a disaster event; and
distributing said disaster relief supplies to members of said community following said disaster event.

2. The method of claim 1 including using first responders from a government authority to distribute said disaster relief supplies.

3. The method of claim 2 wherein said government authority is an emergency management agency.

4. The method of claim 2 wherein said government authority is a police department.

5. The method of claim 2 wherein said government authority is a fire department.

6. The method of claim 1, including selecting a fire station as a location for one of said storage structures.

7. The method of claim 6, including equipping said storage structure at said fire station with a satellite uplink to serve as a communications back-up system for said fire station should said disaster event compromise normal communication systems.

8. The method of claim 1, including configuring said communications environment to allow broadcasting of a specific social media message to a specified, targeted location.

9. A community disaster safety network, comprising:
a first integrated advertising and storage structure including a first computing device, configured to (a) include a unique identifier, (b) control said first electronic display device and (c) prioritize an emergency message over advertising, and a first electronic display device and a first group of disaster relief supplies dedicated to disaster relief located adjacent a first government building used to shelter civilians in event of a disaster;
a second integrated advertising and storage structure including a second computing device, configured to (a) include a unique identifier, (b) control said first electronic display device and (c) prioritize an emergency message over advertising, and a second electronic display device and a second group of disaster relief supplies dedicated to disaster relief located adjacent a second government building used as a rally point for first responders in event of said disaster;
a third integrated advertising and storage structure including a third computing device, configured to (a) include a unique identifier, (b) control said first electronic display device and (c) prioritize an emergency message over advertising, and a third electronic display device and a third group of disaster relief supplies dedicated to disaster relief located adjacent a public roadway for rapid distribution of said third group of supplies dedicated to disaster relief in event of said disaster; and
a communication environment configured to allow broadcasting of a specific message to a specific computing device of said first computing device, said second computing device and said third computing device.

10. The network of claim 9, wherein said first government building is a school gymnasium.

11. The network of claim 9, wherein said second government building is a fire station.

12. The network of claim 9, wherein said first government building is a school gymnasium and said second government building is a fire station.

13. The network of claim 9 wherein said communication device is further configured to allow broadcasting of a specific social media message to a specific computing device of said first computing device, said second computing device and said third computing device.

14. A community disaster safety network, comprising:
a plurality of integrated advertising and storage structures located at a plurality of locations across a community;
a different computing device provided in each integrated advertising and storage structure of said plurality of integrated advertising and storage structures wherein each different computing device is configured to (a) include a unique identifier for target specific messaging, (b) control an electronic display device carried on said integrated advertising and storage structure in which said computing device is provided and (c) prioritize emergency messaging over advertising;
disaster relief supplies dedicated to disaster relief stored in said plurality of integrated advertising and storage structures; and
a communication environment configured to allow broadcasting of a specific message to a specific, targeted computing device of said different computing devices based upon said unique identifier.
